(19) United States
(12) Patent Application Publication
(10) Pub. No.: US 2024/0386681 A1
(43) Pub. Date: Nov. 21, 2024

(54) INFORMATION PROCESSING APPARATUS, INFORMATION PROCESSING METHOD, AND PROGRAM

(71) Applicant: Sony Group Corporation, Tokyo (JP)

(72) Inventors: Ryosuke MURATA, Kanagawa (JP); Hajime WAKABAYASHI, Tokyo (JP); Makoto Daniel TOKUNAGA, Kanagawa (JP); Haruka FUJISAWA, Kanagawa (JP); Yuki TAKEDA, Kanagawa (JP)

(73) Assignee: Sony Group Corporation, Tokyo (JP)

(21) Appl. No.: 18/688,619

(22) PCT Filed: Mar. 22, 2022
(86) PCT No.: PCT/JP2022/013179

§ 371 Date: Mar. 1, 2024

(30) Foreign Application Priority Data
Sep. 10, 2021 (JP) 2021-147505

(51) Int. Cl. G06T 19/00; G06T 7/20; G06V 20/20

(52) U.S. Cl. CPC G06T 19/006; G06T 7/20; G06V 20/20

(57) ABSTRACT

An information processing apparatus includes: a movement determination unit configured to determine a movement of a physical object disposed in a real space; a target physical object determination unit configured to determine a new target physical object from among other physical objects in a case where the target physical object that is a target of behavior of a virtual object moves; a virtual object behavior update unit configured to determine behavior of the virtual object in relation to the new target physical object in a case where the new target physical object is determined; and a display control unit configured to display the virtual object in the real space with the determined behavior.

### TECHNICAL FIELD

The present technology relates to an information processing apparatus, an information processing method, and a program, and particularly relates to a technology field of an information processing apparatus that displays a virtual object formed by applying, as a target of behavior, a physical object disposed in a real space.

### BACKGROUND ART

In recent years, an information processing apparatus capable of implementing so-called augmented reality (AR) in which a virtual object is superimposed on a real space and visually recognized has been proposed.

### CITATION LIST

### Patent Document

Patent Document 1: Japanese Patent Application Laid-Open No. 2021-96490

### SUMMARY OF THE INVENTION

### Problems to be Solved by the Invention

By the way, in a case where the above-described augmented reality is realized, the information processing apparatus recognizes a physical object disposed in a real space, and determines the behavior of a virtual object with the recognized physical object as a target.

In such a case, when the physical object moves, there is a possibility that the behavior of the virtual object is unstable. For example, in a case where the virtual object is displayed on the physical object, the virtual object may float at an original position and be displayed even when the physical object moves.

The present technology has been made in view of such a problem, and an object thereof is to reduce instability of the behavior of the virtual object when the virtual object is superimposed and displayed on the physical object.

### Solutions to Problems

According to an aspect of the present technology, there is provided an information processing apparatus including: a movement determination unit configured to determine a movement of a physical object disposed in a real space; a target physical object determination unit configured to determine a new target physical object from among other physical objects in a case where the target physical object that is a target of behavior of a virtual object moves; a virtual object behavior update unit configured to determine behavior of the virtual object in relation to the new target physical object in a case where the new target physical object is determined; and a display control unit configured to display the virtual object in the real space with the determined behavior.

According to the aspect, in a case where the target physical object that is the target of the behavior of the virtual object moves, the information processing apparatus can determine a new target physical object, and move the virtual object so as to perform the behavior in relation to the new target physical object.

### BRIEF DESCRIPTION OF DRAWINGS

FIG. 1 is a diagram illustrating a configuration of an information processing system according to an embodiment of the present technology.

FIG. 2 is a diagram illustrating a display example of augmented reality.

FIG. 3 is a diagram illustrating a configuration of an information processing apparatus.

FIG. 4 is a diagram illustrating a functional configuration of a CPU and information stored in a storage unit.

FIG. 5 is a diagram illustrating a configuration of a server.

FIG. 6 is a diagram illustrating a functional configuration of a CPU and information stored in a storage unit.

FIG. 7 is a diagram illustrating physical object information recognized by a physical object recognition unit.

FIG. 8 is a diagram illustrating an example of move-display of a virtual object.

FIG. 9 is a flowchart illustrating a flow of target physical object update processing.

FIG. 10 is a flowchart illustrating a flow of physical object movement determination processing.

FIG. 11 is a diagram illustrating physical object movement determination processing.

FIG. 12 is a flowchart illustrating a flow of target physical object determination processing.

FIG. 13 is a flowchart illustrating a flow of virtual object behavior update processing.

FIG. 14 is a diagram illustrating an example of display in a case where a virtual object is a moving object.

FIG. 15 is a diagram illustrating an example of display in a case where a virtual object is not a moving object.

FIG. 16 is a diagram illustrating another example of display in a case where a virtual object is not a moving object.

### MODE FOR CARRYING OUT THE INVENTION

Hereinafter, embodiments according to the present technology will be described in the following order with reference to the accompanying drawings.
<1. Information Processing system>
<2. Information Processing Apparatus>
<3. Server>
<4. Augmented Reality Display Processing>
<5. Target Physical Object Update Processing>
<6. Modification Example>
<7. Summary>
<8. Present Technology>

### 1. System Configuration

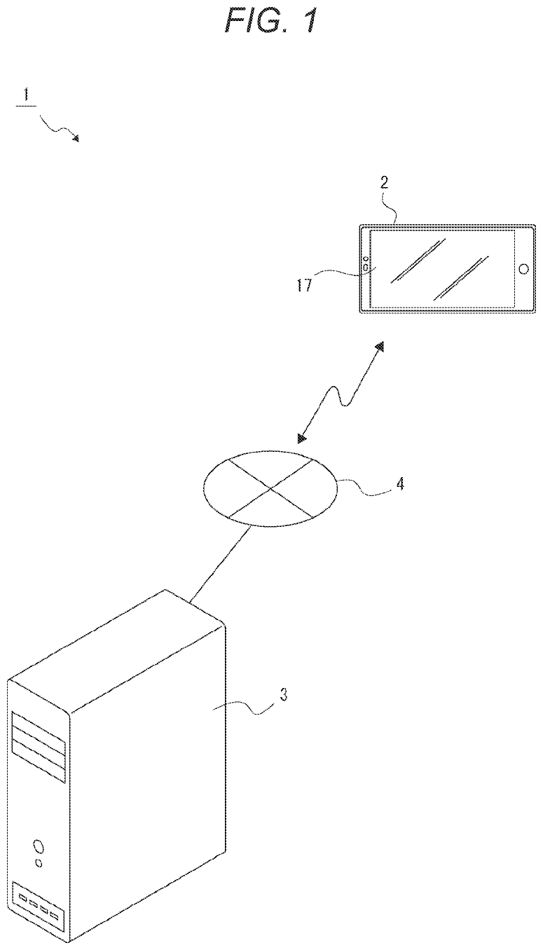

FIG. 1 is a diagram illustrating a configuration of an information processing system 1 according to an embodiment of the present technology. As illustrated in FIG. 1, the information processing system 1 includes an information processing apparatus 2 and a server 3 according to the embodiment of to the present technology. The information processing apparatus 2 and the server 3 are connected to a network 4 such as the Internet, and can communicate with each other via the network 4.

The information processing apparatus 2 is an apparatus capable of implementing augmented reality in which a virtual object is superimposed on a real space and visually recognized, such as a smartphone, a head mounted display (HMD), or the like.

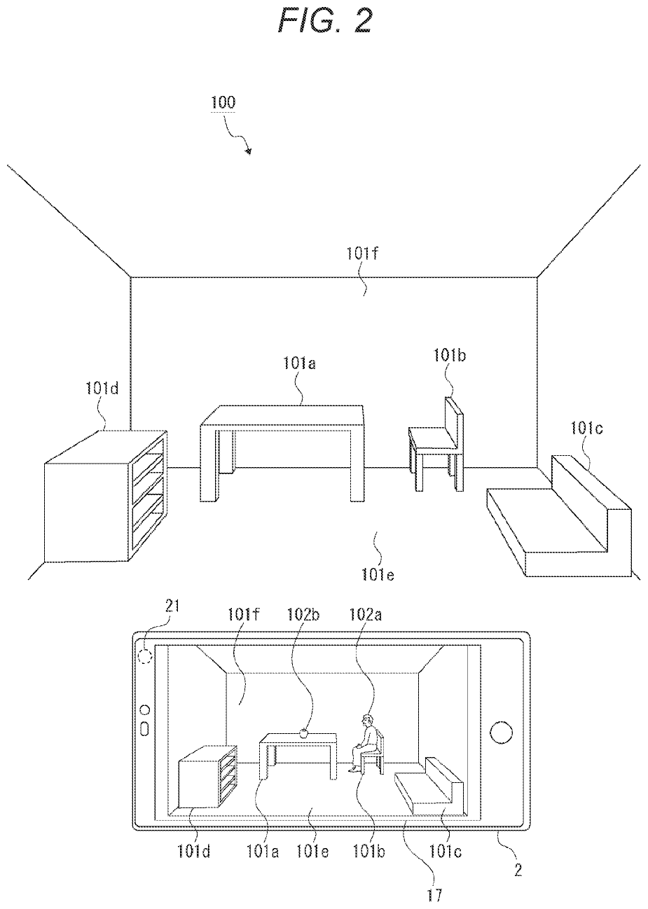

In the embodiment, as an example, a case where the information processing apparatus 2 is a smartphone will be described. In a case where the information processing apparatus 2 is a smartphone, the information processing apparatus 2 can implement augmented reality by video see-through in which a virtual object is superimposed on an image of a real space imaged by an imaging unit 21 (refer to FIG. 2) to be displayed on a display unit 17. However, the information processing apparatus 2 may be of a see-through type in which the virtual object is displayed on the display unit while the real space is visually recognized with naked eyes, or a retinal projection type in which the virtual object is directly projected onto eyeballs by scanning the real space with laser light while the real space is visually recognized with the naked eyes.

Furthermore, in the embodiment, a case where one information processing apparatus 2 is provided will be described, but a plurality of information processing apparatuses 2 may be provided.

As will be described in detail later, the server 3 generates a three-dimensional model (shape information) of the real space by acquiring an image captured by the imaging unit 21 of the information processing apparatus 2 and performing image analysis, and generates and holds attribute information of a physical object disposed in the real space. Then, the server 3 transmits the shape information and attribute information of the physical object disposed in the real space to the information processing apparatus 2 in a timely manner.

As a result, the information processing apparatus 2 can realize a so-called AR cloud that displays a virtual object formed by applying, as the target of behavior, the physical object disposed in the real space on the basis of the shape information and the attribute information.

FIG. 2 is a diagram illustrating a display example of the augmented reality. As illustrated in FIG. 2, a plurality of physical objects 101 is disposed in a real space 100. In the example of FIG. 2, a desk 101a, a chair 101b, a sofa 101c, a shelf 101d, a floor 101e, and a wall 101f are provided as the physical objects 101.

When such a real space 100 is imaged by the imaging unit 21, the information processing apparatus 2 causes the display unit 17 to display an image in which a virtual object 102 is superimposed on the real space 100. In this example, a person 102a and an apple 102b are provided as the virtual objects 102.

Furthermore, in the example of FIG. 2, the apple 102b is disposed on the desk 101a, and the person 102a sits on the chair 101b. In other words, the desk 101a can be the physical object 101 that is the target of the behavior of the apple 102b, and the chair 101b can be the physical object 101 that is the target of the behavior of the person 102a.

Hereinafter, the physical object 101 that is the target of the behavior of the virtual object 102 may be referred to as a target physical object.

### 2. Information Processing Apparatus

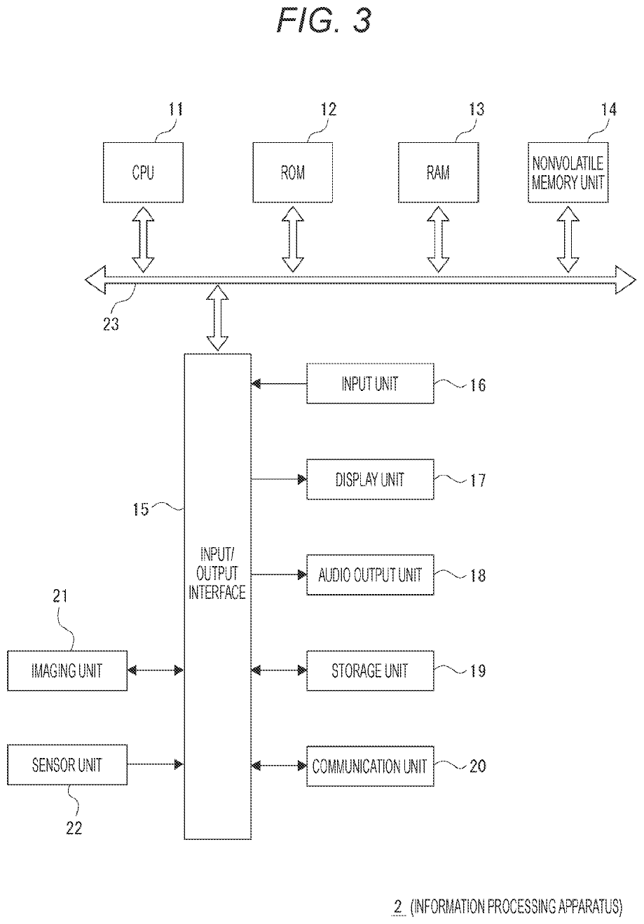

FIG. 3 is a diagram illustrating a configuration of the information processing apparatus 2. As illustrated in FIG. 3, the information processing apparatus 2 includes a central processing unit (CPU) 11, a read only memory (ROM) 12, a random access memory (RAM) 13, and a nonvolatile memory unit 14. The nonvolatile memory unit 14 includes, for example, an electrically erasable programmable read-only memory (EEP-ROM).

The CPU 11 executes various types of processing according to a program stored in the ROM 12 or the nonvolatile memory unit 14 or a program loaded to the RAM 13 from a storage unit 19 to be described later. The RAM 13 also appropriately stores data and the like necessary for the CPU 11 to execute various types of processing.

The CPU 11, the ROM 12, the RAM 13, and the nonvolatile memory unit 14 are connected to each other via a bus 23. An input/output interface 15 is also connected to the bus 23.

The input/output interface 15 may be connected with an input unit 16 that allows a user to perform an input operation, a display unit 17 including a liquid crystal panel or an organic electroluminescence (EL) panel, an audio output unit 18 including a speaker, the storage unit 19, a communication unit 20, and the like.

The input unit 16 means an input device to be used by the user who uses the information processing apparatus 2. For example, a touch panel provided on the upper surface of the display unit 17 is assumed as the input unit 16. Furthermore, as the input unit 16, various types of manipulation elements and operation devices such as a keyboard, a mouse, a button, a dial, a touch panel, a touch pad, a remote controller, and the like are assumed. A user operation is detected by the input unit 16, and a signal corresponding to the input operation is interpreted by the CPU 11.

The display unit 17 displays various types of images on the basis of an instruction from the CPU 11. Furthermore, the display unit 17 may display various types of operation menus, icons, messages, and the like, that is, performs display as a graphical user interface (GUI), on the basis of the instruction from the CPU 11.

The storage unit 19 includes, for example, a storage medium such as a solid-state memory. The storage unit 19 can store, for example, various types of information to be described later. Furthermore, the storage unit 19 can also be used to store program data for causing the CPU 11 to execute various types of processing.

The communication unit 20 performs communication processing via the network 4, and wired or wireless communication (for example, near field communication, and the like) with a peripheral device. Specifically, the communication unit 20 is communicable with the server 3.

Furthermore, the imaging unit 21 and a sensor unit 22 are connected to the input/output interface 15.

The imaging unit 21 includes, for example, a solid-state imaging element such as a complementary metal oxide semiconductor (CMOS) type or a charge coupled device (CCD) type. In the solid-state imaging element, for example, a plurality of pixels, which has photoelectric conversion elements such as photodiodes, is two-dimensionally arranged. The imaging unit 21 performs, for example, correlated double sampling (CDS) processing, automatic gain control (AGC) processing, or the like on an electrical signal obtained by photoelectric conversion for each pixel, and further performs analog/digital (A/D) conversion processing to obtain image data as digital data (live-view image data).

The imaging unit 21 is a so-called outer camera provided on the back side of the information processing apparatus 2. However, the imaging unit 21 may be an inner camera provided on the opposite side of the back surface of the information processing apparatus 2 (that is, provided on the same surface side as the display unit 17).

The sensor unit 22 comprehensively indicates various sensors for detecting actions of the user. For example, the sensor unit 22 is provided with a motion sensor for detecting motions of the information processing apparatus 2, such as an acceleration sensor, an angular velocity sensor, and the like.

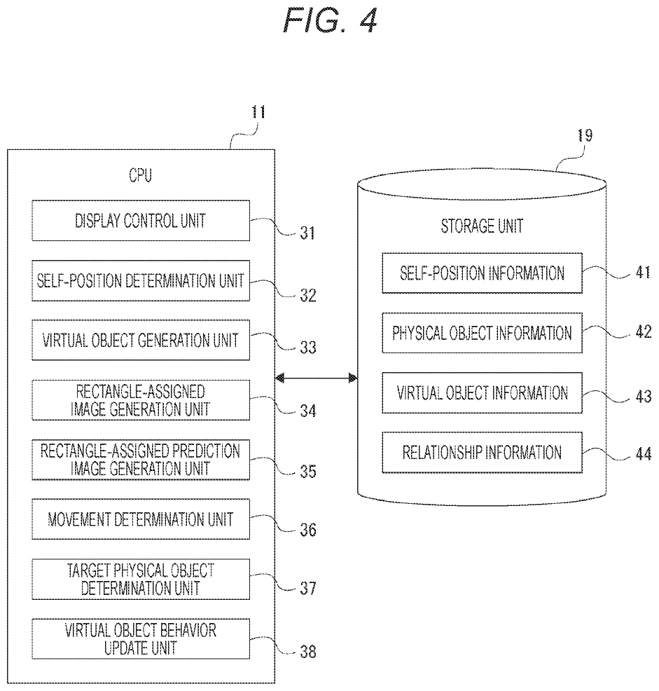

FIG. 4 is a diagram illustrating a functional configuration of the CPU 11 and information stored in the storage unit 19. Note that, here, the functional configuration of the CPU 11 and the information stored in the storage unit 19 will be briefly described, and the details thereof will be described later.

As illustrated in FIG. 4, in the embodiment, the CPU 11 functions as a display control unit 31, a self-position determination unit 32, a virtual object generation unit 33, a rectangle-assigned image generation unit 34, a rectangle-assigned prediction image generation unit 35, a movement determination unit 36, a target physical object determination unit 37, and a virtual object behavior update unit 38.

Furthermore, the storage unit 19 stores self-position information 41, physical object information 42, virtual object information 43, and relationship information 44.

The self-position information 41 is information indicating the position and orientation of the information processing apparatus 2.

The physical object information 42 includes shape information and attribute information of the physical object 101.

The virtual object information 43 includes shape information and behavior information of the virtual object 102.

The relationship information 44 is information indicating a relationship between the physical object 101 and the virtual object 102.

The display control unit 31 performs display control to display an image on the display unit 17. For example, the display control unit 31 superimposes the virtual object 102 on the real space imaged by the imaging unit 21 and displays the image on the display unit 17.

The self-position determination unit 32 determines the position and orientation of the information processing apparatus 2. For example, the self-position determination unit 32 determines the position and orientation of the information processing apparatus 2 by executing the known vision positioning system (VPS) algorithm on the basis of an image captured by the imaging unit 21 and physical object information 42 to be described later in detail. Furthermore, the self-position determination unit 32 may determine the position and orientation of the information processing apparatus 2 by frequently tracking the movement of the information processing apparatus 2 from the time of activation on the basis of the movement of the information processing apparatus 2, which is detected by the sensor unit 22. That is, the self-position determination unit 32 is only required to be capable of determining the position and orientation of the information processing apparatus 2, and can use various known methods. Then, the self-position determination unit 32 stores information indicating the determined position and orientation of the information processing apparatus 2 in the storage unit 19 as the self-position information 41.

The virtual object generation unit 33 determines the virtual object 102 to be disposed in relation to the real space 100 and determines the behavior of the virtual object 102. Then, the virtual object generation unit 33 stores the determined virtual object and information regarding the behavior of the determined virtual object in the storage unit 19 as the virtual object information 43. Furthermore, in a case where there is a target physical object that is a target of the behavior of the virtual object 102, the virtual object generation unit 33 stores information indicating the relationship between the virtual object 102 and the target physical object in the storage unit 19 as the relationship information 44.

The rectangle-assigned image generation unit 34 performs two-dimensional class classification on the image captured by the imaging unit 21, and sets a rectangular region surrounding the physical object 101 subjected to the class classification. Then, the rectangle-assigned image generation unit 34 generates a rectangle-assigned image formed by assigning a rectangular region to the image.

On the basis of the self-position information 41 and the physical object information 42, the rectangle-assigned prediction image generation unit 35 creates a prediction image of a three-dimensional model corresponding to the image captured by the imaging unit 21, and generates a rectangular region surrounding the physical object 101 in the created prediction image. Then, the rectangle-assigned image generation unit 34 generates a rectangle-assigned prediction image formed by assigning a rectangular region to the prediction image.

The movement determination unit 36 determines the movement of the physical object 101 disposed in the real space on the basis of the image captured by the imaging unit 21 and the physical object information 42.

In a case where the target physical object that is the target of the behavior of the virtual object 102 moves, the target physical object determination unit 37 determines a new target physical object from the other physical objects 101.

In a case where the target physical object determination unit 37 determines a new target physical object, the virtual object behavior update unit 38 generates the relationship information 44 for associating the virtual object 102 with the new target physical object. Furthermore, the virtual object behavior update unit 38 determines the behavior of the virtual object 102 in relation to the new target physical object and stores this behavior of the virtual object 102 as the virtual object information 43. Therefore, the display control unit 31 can display the virtual object 102 in relation to the real space with the determined behavior.

### 3. Server

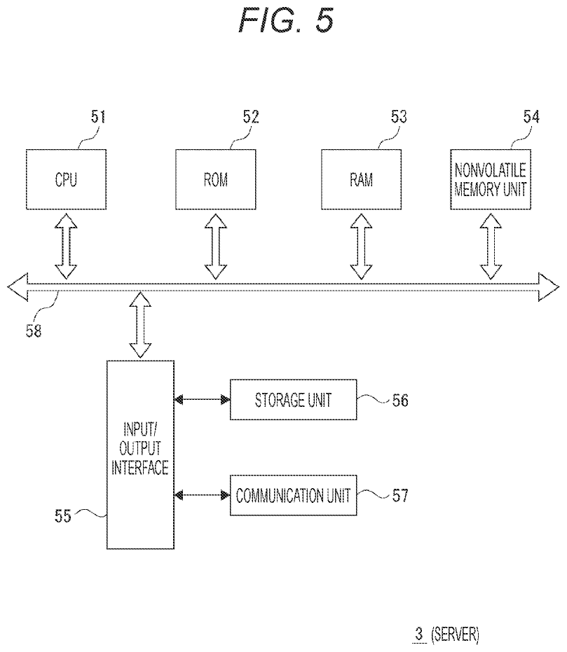

FIG. 5 is a diagram illustrating a configuration of the server 3. As illustrated in FIG. 5, the server 3 includes a CPU 51, a ROM 52, a RAM 53, and a nonvolatile memory unit 54. The nonvolatile memory unit 54 includes, for example, an EEP-ROM.

The CPU 51 executes various types of processing according to a program stored in the ROM 52 or the nonvolatile memory unit 54 or a program loaded to the RAM 53 from a storage unit 56 to be described later. The RAM 53 also appropriately stores data and the like necessary for the CPU 51 to execute various types of processing.

The CPU 51, the ROM 52, the RAM 53, and the nonvolatile memory unit 54 are connected to each other via a bus 58. An input/output interface 55 is also connected to the bus 58.

The storage unit 56, a communication unit 57, and the like can be connected to the input/output interface 55.

The storage unit 56 includes, for example, a storage medium such as a solid-state memory. The storage unit 56 can store, for example, various types of information to be described later. Furthermore, the storage unit 56 can also be used to store program data for causing the CPU 51 to execute various types of processing.

The communication unit 57 performs communication processing via the network 4, and wired or wireless communication (for example, near field communication, and the like) with a peripheral device. Specifically, the communication unit 20 is configured to be communicable with the information processing apparatus 2.

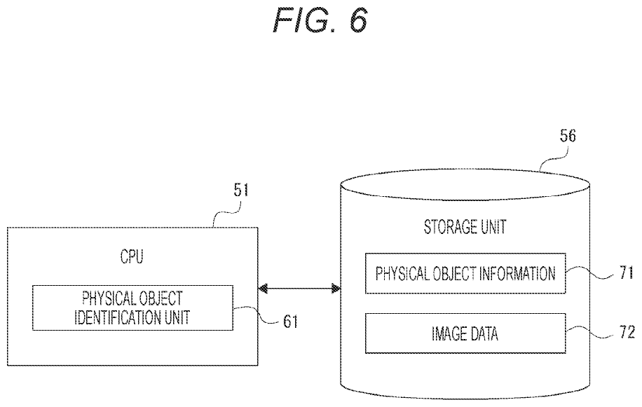

FIG. 6 is a diagram illustrating a functional configuration of the CPU 51 and information stored in the storage unit 56. As illustrated in FIG. 6, in the embodiment, the CPU 51 functions as a physical object identification unit 61. Furthermore, the storage unit 56 stores physical object information 71 and image data 72.

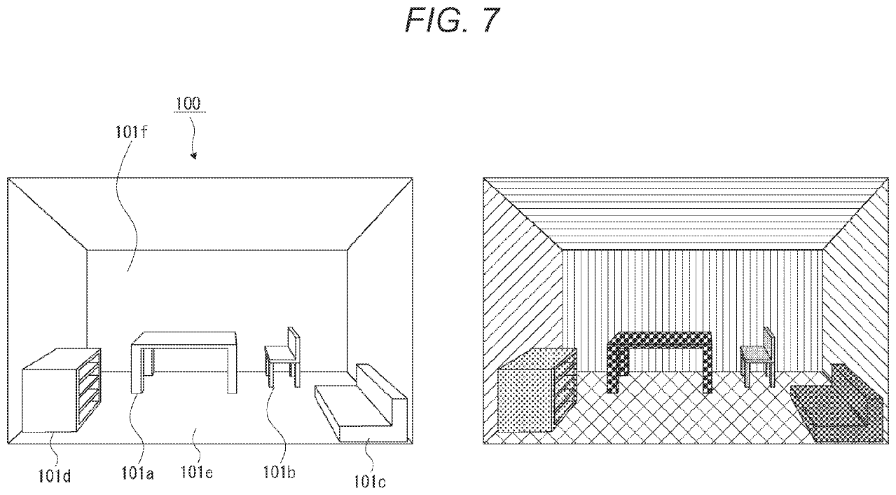

FIG. 7 is a diagram illustrating the physical object information 71 identified by the physical object identification unit 61. In the embodiment, when augmented reality is implemented by the information processing apparatus 2, the real space 100 is imaged in advance by the imaging unit 21 of the information processing apparatus 2, and image analysis is performed on the captured image by the server 3 to generate the physical object information 71.

For example, the real space 100 as illustrated on the left side of FIG. 7 is imaged by the imaging unit 21 and the captured image data is transmitted to the server 3. When the server 3 receives the transmitted image data, the server 3 causes the storage unit 56 to store the transmitted image data as the image data 72. Then, the physical object identification unit 61 reads the image data 72 from the storage unit 56 and executes known image analysis (for example, semantic segmentation) to generate the physical object information 71. Note that another method may be used as long as the physical object information 71 regarding the physical object 101 disposed in the real space 100 can be generated on the basis of the image data 72.

Specifically, the physical object identification unit 61 divides the image based on the image data 72 for each physical object 101, and generates a three-dimensional model (shape information) configured by a mesh for each physical object 101 as illustrated on the right side of FIG. 7. Note that the shape information also includes physical information such as the position and size of the physical object 101.

Furthermore, the physical object identification unit 61 identifies attribute information for each physical object 101. The attribute information indicates various types of information (meta information) of the physical object 101, and includes a name, an ID, a material, a relation, and an affordance. Note that the relation indicates relationship information such as a position and an orientation with another physical object 101, and the affordance defines a type of behavior (place, sit, image, and the like) to be a target of the virtual object.

For example, with respect to the desk 101a, Desk is set as the name, Desk A is set as the ID, Brown color is set as the material, Desk in front of chair is set as the relation, and Place-able (place) is set as the affordable. Furthermore, with respect to the chair 101b, Chair is set as the name, Chair A is set as the ID, White color is set as the material, Desk in front of chair is set as the relation, and Sittable (sit) is set as the affordable.

As described above, when the shape information and attribute information of the physical object 101 are generated on the basis of the image data transmitted from the information processing apparatus 2, the physical object identification unit 61 stores the shape information and attribute information of the physical object 101 in the storage unit 56 as the physical object information 71. Then, the server 3 transmits the physical object information 71 to the information processing apparatus 2 at a predetermined timing. When receiving the physical object information 71 transmitted from the server 3, the information processing apparatus 2 stores the received physical object information 71 as the physical object information 42. Therefore, the physical object information 71 stored in the server 3 and the physical object information 42 stored in the information processing apparatus 2 are substantially the same. However, depending on the transmission/reception timing, the physical object information 42 stored in the information processing apparatus 2 may be information older than the physical object information 71 stored in the server 3.

### 4. Augmented Reality Display Processing

Next, augmented reality display processing performed by the information processing apparatus 2 will be described. Note that the augmented reality display processing to be described herein is an example, and various methods can be used.

When the augmented reality display processing is started, first, imaging of the real space 100 (capturing of a live-view image) is started by the imaging unit 21. Furthermore, the self-position determination unit 32 determines the position and orientation of the information processing apparatus 2. Then, the virtual object generation unit 33 specifies the three-dimensional model corresponding to the physical object 101 disposed in the real space 100 captured by the imaging unit 21 by matching the image captured by the imaging unit 21 with the physical object information 42 (shape information) stored in the storage unit 19.

Thereafter, the virtual object generation unit 33 determines any one of the physical objects 101 corresponding to the specified three-dimensional model as the target physical object on the basis of a predetermined condition, and determines the virtual object 102 for the determined target physical object and the behavior of the virtual object 102.

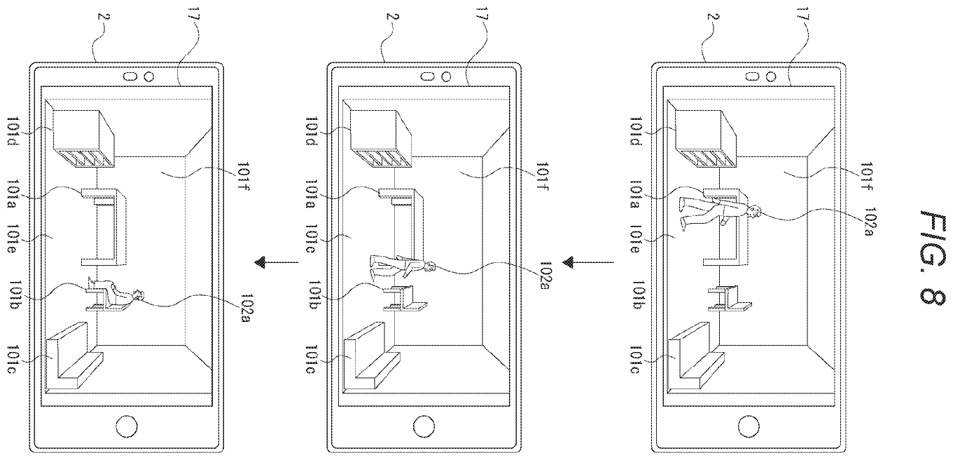

FIG. 8 is a diagram illustrating an example of move-display of the virtual object 102. For example, the virtual object generation unit 33 determines the behavior of the apple 102b placed on the desk 101a while rolling, or determines the behavior of the person 102a walking on the floor 101e from a predetermined position and approaching the chair 101b to sit on the chair 101b as illustrated in FIG. 8.

The display control unit 31 moves and displays the virtual object 102 in the image captured by the imaging unit 21 according to the behavior determined by the virtual object generation unit 33. Therefore, the information processing apparatus 2 can implement augmented reality.

Meanwhile, as described above, the physical object information 71 is generated by the server 3 on the basis of the image captured by the imaging unit 21, and the behavior of the virtual object is determined on the basis of the physical object information 71 (physical object information 42).

Therefore, in a case where the physical object 101 is moved, the actual position of the physical object 101 may be different from the position of the three-dimensional model of the physical object 101 stored as the physical object information 42, that is, the shape information.

For example, in a case where the desk 101a is moved, when the shape information of the desk 101a remains at the position before the movement in the physical object information 42, an apple 102b may be placed on the desk 101a that does not actually exist. In such a case, the apple 102b floats in the air, and the user feels uncomfortable.

Furthermore, in a case where the chair 101b is moved, even when the movement of the chair 101b can be recognized, the person 102a may be in a state of sitting without the chair 101b until the movement of the chair 101b is recognized. Furthermore, when the chair 101b is recognized as another chair, the person 102a may be continuously displayed in a state of sitting without the chair 101b.

As described above, in a case where the target physical object is moved, the behavior of the virtual object 102 may become unnatural.

Therefore, in a case where the target physical object is moved, the information processing apparatus 2 performs target physical object update processing for reducing unnatural behavior of the virtual object 102 in relation to the target physical object.

### 5. Target Physical Object Update Processing

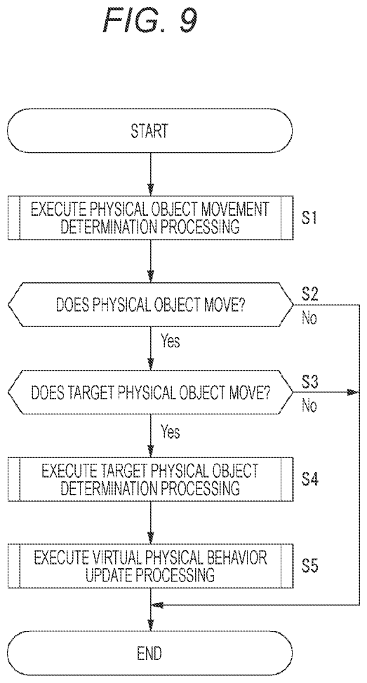

FIG. 9 is a flowchart illustrating a flow of the target physical object update processing. As illustrated in FIG. 9, when the target physical object update processing is started, in step S1, the CPU 11 performs physical object movement determination processing of determining whether the physical object 101 is moving. Note that the physical object movement determination processing will be described later in detail.

Thereafter, in step S2, the CPU 11 determines whether there is a moved physical object 101 on the basis of the result of the physical object movement determination processing. In a case where there is the physical object 101 that has moved (Yes in step S2), in step S3, the CPU 11 determines whether the physical object 101 that has moved is the target physical object. In a case where the physical object 101 that has moved is the target physical object (Yes in step S3), in step S4, the CPU 11 executes target physical object determination processing of determining a new target physical object that is a target of the behavior of the virtual object 102. Note that the target physical object determination processing will be described later in detail.

Furthermore, in step S5, the CPU 11 executes virtual object behavior update processing of determining the behavior of the virtual object 102 in relation to the new target physical object determined in the target physical object determination processing, and ends the target physical object update processing.

On the other hand, in a case where there is no physical object 101 that has moved (No in step S2) and in a case where the physical object 101 that has moved is not the target physical object (No in step S3), the CPU 11 ends the target physical object update processing without performing the processing in steps S4 and S5.

### [5.1 Physical Object Movement Determination Processing]

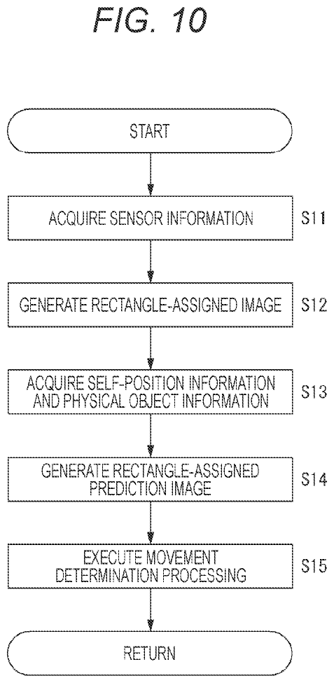

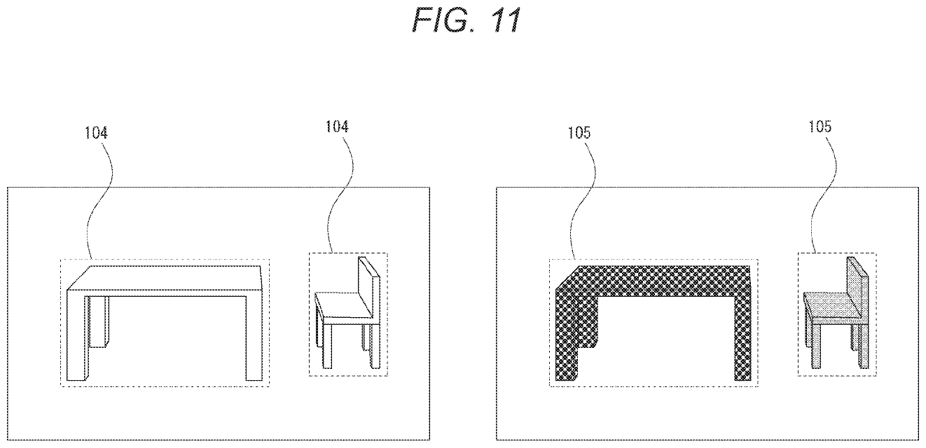

FIG. 10 is a flowchart illustrating a flow of the physical object movement determination processing. FIG. 11 is a diagram illustrating the physical object movement determination processing.

As illustrated in FIG. 10, when the physical object movement determination processing is started, in step S11, the rectangle-assigned image generation unit 34 acquires information indicating the movement of the information processing apparatus 2 from the sensor unit 22. Then, in step S12, the rectangle-assigned image generation unit 34 executes the known two-dimensional class classification processing on the image captured by the imaging unit 21. In the class classification processing, as illustrated on the left side of FIG. 11, the physical object 101 appearing in the image is detected, and a rectangular region 104 surrounding the detected physical object 101 is set. Then, the rectangle-assigned image generation unit 34 generates a rectangle-assigned image formed by assigning the rectangular region 104 to the image. In the example of FIG. 11, the rectangular regions 104 are set on the desk 101a and the chair 101b.

Furthermore, in step S13, the rectangle-assigned prediction image generation unit 35 acquires the self-position information 41 stored in the storage unit 19 and the physical object information 42 stored in the storage unit 19. Then, in step S14, the rectangle-assigned prediction image generation unit 35 specifies a range that the imaging unit 21 will be imaging on the basis of the self-position information 41, and generates a prediction image including a three-dimensional model (shape information) included in the range. Furthermore, as illustrated on the right side of FIG. 11, the rectangle-assigned prediction image generation unit 35 sets a rectangular region 105 surrounding the three-dimensional model included in the prediction image. Then, the rectangle-assigned prediction image generation unit 35 generates a rectangle-assigned prediction image formed by assigning the rectangular region 105 to the prediction image. In the example of FIG. 11, the rectangular regions 105 are set to the three-dimensional models corresponding to the desk 101a and the chair 101b.

Thereafter, in step S15, the movement determination unit 36 executes movement determination processing of determining whether the physical object 101 has moved by comparing the rectangle-assigned image and the rectangle-assigned prediction image. Here, the movement determination unit 36 determines whether the physical object 101 has moved by comparing the position and size of the rectangular region 104 and the position and size of the rectangular region 105 which respectively correspond to the rectangle-assigned image and the rectangle-assigned prediction image.

### [5.2 Target Physical Object Determination Processing]

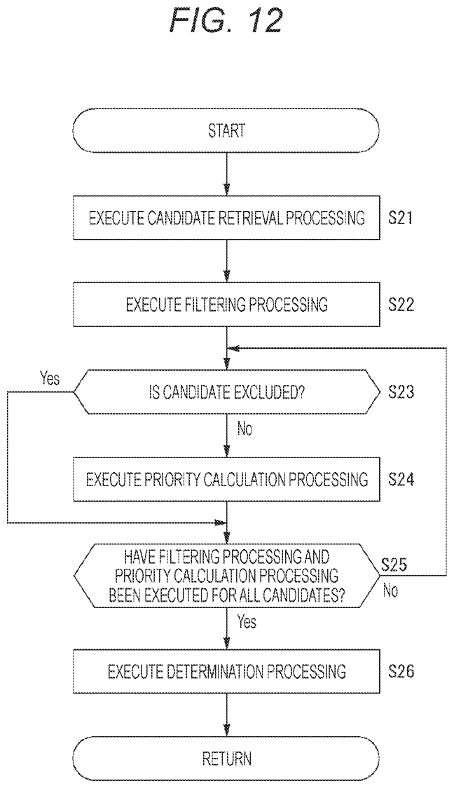

FIG. 12 is a flowchart illustrating a flow of the target physical object determination processing.

As described above, in a case where the target physical object that is the target of the behavior of the virtual object 102 moves, the target physical object determination processing is executed.

As illustrated in FIG. 12, when the target physical object determination processing is started, in step S21, the target physical object determination unit 37 retrieves, from a plurality of the physical objects 101, a candidate for the target physical object to be the target of the behavior of the virtual object 102 instead of the target physical object that has moved and has been the target of the behavior of the virtual object 102 so far (hereinafter, referred to as an old target physical object).

For example, the target physical object determination unit 37 retrieves a physical object 101 that matches the affordance of the old target physical object as a candidate. Specifically, in a case where Sittable is included as the affordance of the old target physical object, the physical object 101 including Sittable as the affordance is retrieved as a candidate. Note that, in a case where the number of affordances of the old target physical object is two or more, the physical objects 101 matching all the affordances may be retrieved as candidates, or the physical objects 101 matching one or more affordances may be retrieved as candidates.

Furthermore, the target physical object determination unit 37 may retrieve a candidate by using a condition used for determining the old target physical object. Specifically, in a case where it is set as the condition that Sittable is included as the affordance and Desk in front of chair is included as the relation, the physical object 101 satisfying the condition is retrieved as a candidate. Note that, here, it is desirable to retrieve the physical object 101 satisfying all the conditions as a candidate. However, even in a case where some conditions are not satisfied, the physical object 101 may be retrieved as a candidate as long as other conditions are satisfied.

Furthermore, in a case where the virtual object 102 is placed on the old target physical object, the target physical object determination unit 37 may retrieve, as a candidate, the physical object 101 to which the old target physical object is substantially similar in plane size or height. In this way, it is possible to retrieve the physical object 101 as a candidate even at a place where books are stacked.

Furthermore, the target physical object determination unit 37 may combine the above-described methods. For example, the target physical object determination unit 37 retrieves the physical object 101 that matches the affordance of the old target physical object as a candidate, and in a case where no candidate is found by this method, the candidate is retrieved using the condition used for determining the old target physical object. Furthermore, in a case where no candidate is found by this method, the target physical object determination unit 37 may retrieve, as a candidate, the physical object 101 to which the old target physical object is substantially similar in plane size or height.

Moreover, the target physical object determination unit 37 may set, as a final candidate, the physical object 101 retrieved as a candidate by a plurality of methods among the methods described above.

Next, in step S22, the target physical object determination unit 37 selects any of the candidates retrieved in the candidate retrieval processing, and performs filtering processing of excluding the selected candidate in a case where the selected candidate is obviously unsettable as the target physical object.

Specifically, the target physical object determination unit 37 calculates a distance between the physical object 101 as the candidate and the information processing apparatus 2, and in a case where the calculated distance is larger than a predetermined distance threshold, excludes the candidate. Here, the physical object 101 having a long distance from the user is excluded from the candidates.

Furthermore, in a case where the user cannot visually recognize the physical object 101 as a candidate, the target physical object determination unit 37 may exclude the candidate. For example, in a case where the physical object 101 as a candidate and the information processing apparatus 2 are on different floors (for example, the first floor and the second floor), in a case where there is the physical object 101 such as a ceiling, a wall, or a floor between the physical object 101 as a candidate and the information processing apparatus 2, or in a case where the physical object 101 as a candidate and the information processing apparatus 2 are in different rooms, it is determined that the user cannot visually recognize the physical object 101. These determinations can be used in a case where the floor or the room is known for the physical object 101 as a candidate and the information processing apparatus 2. Here, the physical object 101 present in a floor or room different from the user's place is excluded from the candidates.

Furthermore, the target physical object determination unit 37 may exclude a candidate not satisfying the condition used for determining the old target physical object. For example, in a case where there is a “plane larger than 50 cm square” as a size condition, the candidate is excluded in a case where the condition is not satisfied. Here, the candidate not satisfying the condition is excluded.

Furthermore, the target physical object determination unit 37 may exclude a candidate set for the target virtual object that is already the target of the behavior of another virtual object 102.

Note that the target physical object determination unit 37 may exclude the candidate by one or a plurality of methods among a plurality of the methods described above.

Subsequently, in step S23, the target physical object determination unit 37 determines whether the candidate has been excluded in the filtering processing in step S22. In a case where the candidate has not been excluded (No in step S23), the processing proceeds to step S24. In a case where the candidate has been excluded (Yes in step S23), the processing proceeds to step S25.

In step S24, the target physical object determination unit 37 executes priority calculation processing of calculating the priority of a candidate.

Specifically, the target physical object determination unit 37 calculates (determines) the priority such that the candidate having a closer distance to the position of the old target physical object or the current virtual object 102 has a higher priority.

Furthermore, the target physical object determination unit 37 may calculate the priority such that the candidate that more matches the condition used for determining the old target physical object has a higher priority.

Furthermore, the target physical object determination unit 37 calculates the priority on the basis of the continuity of the user experience. Here, in the case of the continuity of the user experience in which the user is visually recognizing the virtual object 102, the priority is calculated such that the candidate in the range in which the user can visually recognize have a higher priority. Furthermore, in the case of the continuity of the user experience in which the user is not visually recognizing the virtual object 102, the priority may be calculated such that the candidate outside the range in which the user can visually recognize have a higher priority.

Furthermore, in a case where the reliability of the recognition result of the learning-based object recognition technology is calculated for the physical object 101, the target physical object determination unit 37 may calculate the priority such that the candidate with a higher reliability has a higher priority.

Furthermore, the target physical object determination unit 37 may combine the above-described methods. For example, the target physical object determination unit 37 may set a weighting factor in each method, and calculate the final priority by adding a value obtained by multiplying the priority calculated by each method by the weighting factor.

Thereafter, in step S25, the target physical object determination unit 37 determines whether the filtering processing and the priority calculation processing have been executed for all the candidates. In a case where the filtering processing and the priority calculation processing have not been executed for all the candidates (No in step S25), the target physical object determination unit 37 selects another candidate, and returns to step S22. On the other hand, in a case where the filtering processing and the priority calculation processing has been executed for all the candidates (Yes in step S25), in step S26, the target physical object determination unit 37 executes determination processing. Here, the physical object 101 as a candidate having the highest priority calculated for each candidate is determined as a new target physical object.

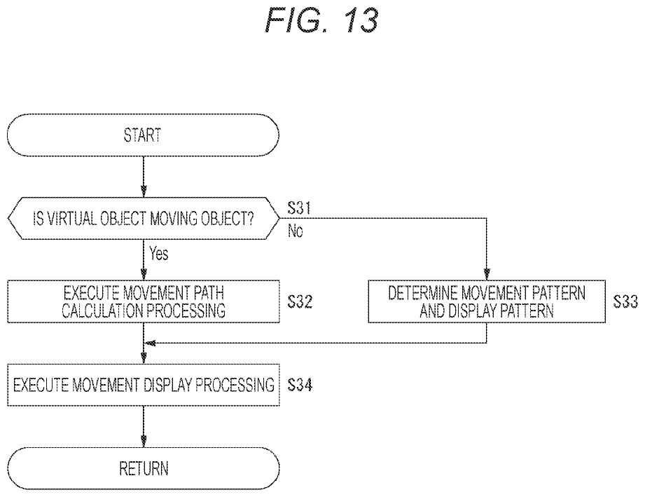

FIG. 13 is a flowchart illustrating a flow of the virtual object behavior update processing. As illustrated in FIG. 13, when the virtual object behavior update processing is started, in step S31, the virtual object behavior update unit 38 determines whether the virtual object 102 is a moving object. Note that whether or not the virtual object 102 is a moving object is set in advance. For example, the virtual object 102 is set as a moving object in a case where the virtual object 102 is a person, a robot, an animal, a vehicle, or the like.

Then, in a case where the virtual object 102 is a moving object (Yes in step S31), in step S32, the virtual object behavior update unit 38 executes movement path calculation processing of retrieving a movement path of the virtual object 102. Here, the virtual object behavior update unit 38 calculates the movement path to the position of a new target physical object by using a known method such as an A* algorithm.

For example, in a case where the virtual object 102 is a person, that is, in a case where the virtual object 102 moves on the ground, a movement path of moving on the floor 101e is calculated. Furthermore, in a case where the virtual object 102 is an airplane, that is, in a case where the virtual object 102 moves in the air, a movement path of moving in the air is calculated.

On the other hand, in a case where the virtual object 102 is not a moving object (No in step S31), the virtual object behavior update unit 38 determines the movement pattern and display pattern of the virtual object 102 in step S33.

As the movement pattern, for example, a method of moving to a position corresponding to a new target physical object in the next frame (instantaneous movement), or a method of moving the current position of the virtual object 102 and the position corresponding to the new target physical object at a predetermined speed in a uniform linear motion can be considered. The virtual object behavior update unit 38 may determine one movement pattern from among a plurality of the movement patterns for each virtual object 102, or may set the movement pattern for each virtual object 102 in advance.

As the display pattern, a method of not displaying the virtual object 102 at the time of movement, a method of displaying the virtual object so as to fade out and fade in at the start and end of the movement, or a method of displaying an effect (for example, a shooting star or the like) around the virtual object 102 being moving is considered. Moreover, as the display pattern, another virtual object 102 may be displayed so as to move the virtual object 102 to be moved. The virtual object behavior update unit 38 may determine one display pattern from among a plurality of the display patterns for each virtual object 102, or may set the display pattern for each virtual object 102 in advance.

Then, in step S34, the display control unit 31 move-displays the virtual object 102 with the calculated movement path or the determined movement pattern and display pattern.

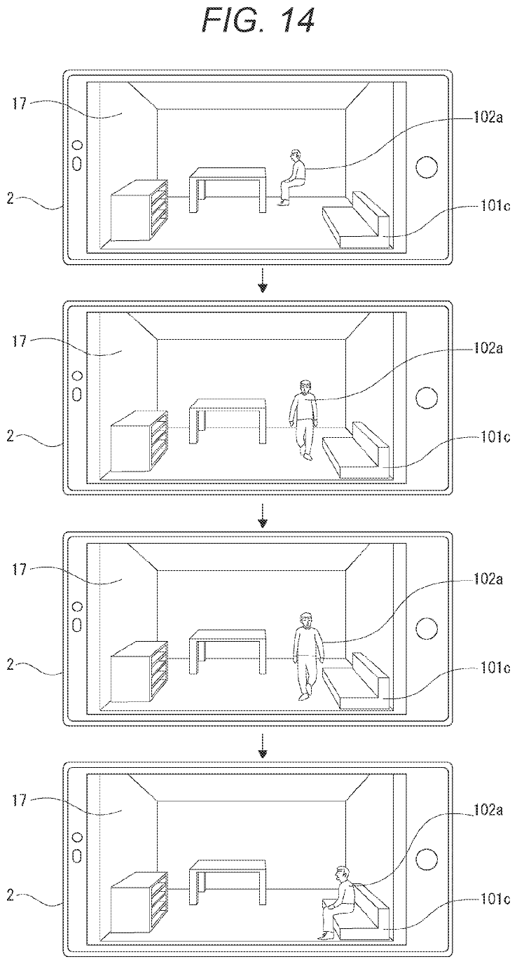

FIG. 14 is a diagram illustrating an example of display in a case where the virtual object 102 is a moving object. In the example of FIG. 14, the old target physical object is the chair 101b, a new target physical object is the sofa 101c, and the virtual object is the person 102a.

In such a case, the virtual object behavior update unit 38 calculates the movement path from a position where the chair 101b is present to the sofa 101c. Then, the display control unit 31 move-displays the person 102a which is the virtual object 102 from the position where the chair 101b is present to the sofa 101c according to the calculated movement path as illustrated in FIG. 14. Thereafter, the display control unit 31 performs display for causing the person 102a to sit on the sofa 101c on the basis of the behavior set for the person 102a.

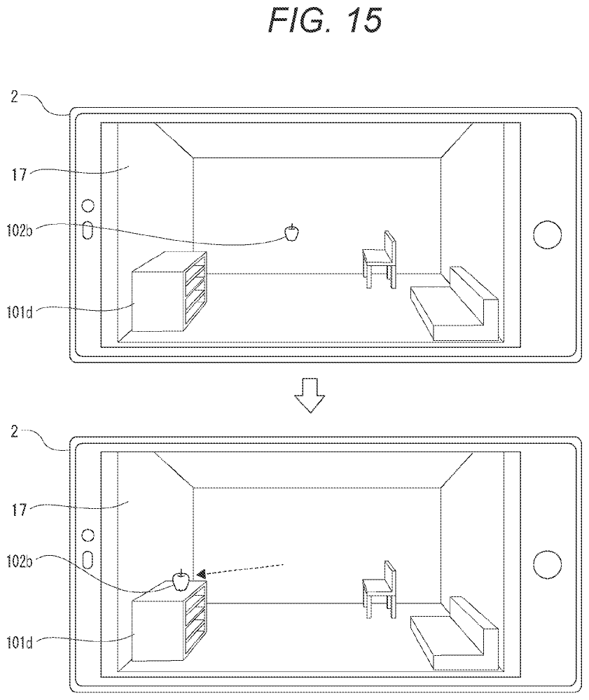

FIG. 15 is a diagram illustrating an example of display in a case where the virtual object 102 is not a moving object. In the example of FIG. 15, the old target physical object is the desk 101a, a new target physical object is the shelf 101d, and the virtual object is the apple 102b. Furthermore, a method of moving at a predetermined speed in a uniform linear motion is determined as the movement pattern, and a method of displaying so as to fade out and fade in at the start and end of the movement is determined as the display pattern.

In this case, as indicated by a broken line in the drawing, the display control unit 31 performs display of movement from the current position to the top of the shelf 101d by a uniform linear motion at a predetermined speed while fading out and fading in.

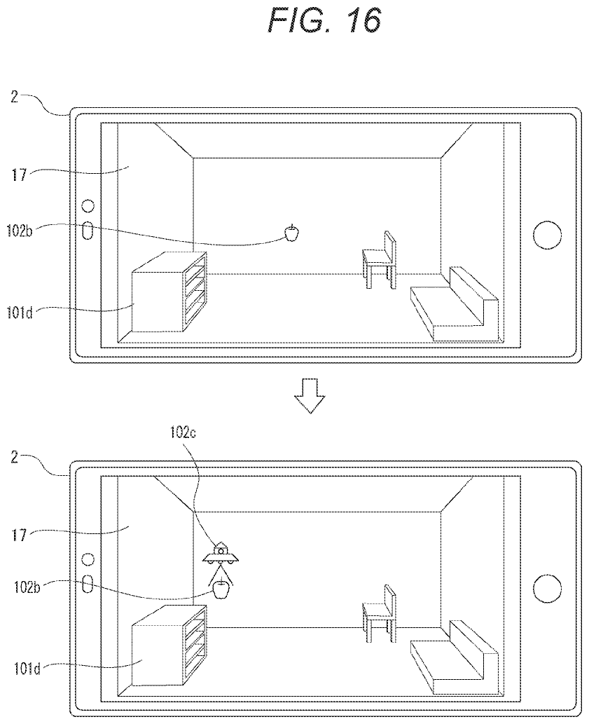

FIG. 16 is a diagram illustrating another example of display in a case where the virtual object 102 is not a moving object. In the example of FIG. 16, the old target physical object is the desk 101a, a new target physical object is the shelf 101d, and the virtual object is the apple 102b. Furthermore, a method of moving at a predetermined speed in a uniform linear motion is determined as the movement pattern, and a method of moving the virtual object to another virtual object (here, UFO 102c) as the display pattern.

In this case, as illustrated in FIG. 16, the display control unit 31 performs display such that the UFO 102c moves the apple 102b from the current position to above the shelf 101d.

### 6. Modification Example

Note that the embodiments are not limited to the specific examples described above and may be configured as various modification examples.

For example, the CPU 11 of the information processing apparatus 2 functions as the display control unit 31, the self-position determination unit 32, the virtual object generation unit 33, the rectangle-assigned image generation unit 34, the rectangle-assigned prediction image generation unit 35, the movement determination unit 36, the target physical object determination unit 37, and the virtual object behavior update unit 38, but some or all of these functional units may function by the CPU 51 of the server 3.

Furthermore, although the CPU 51 of the server 3 functions as the physical object identification unit 61, the physical object identification unit 61 may function by the CPU 11 of the information processing apparatus 2.

### 7. Summary

According to the above-described embodiments, the following effects can be obtained.

The information processing apparatus 2 according to the embodiment includes: a movement determination unit 36 that determines a movement of a physical object 101 disposed in a real space; a target physical object determination unit 37 that determines a new target physical object from among other physical objects 101 in a case where the target physical object that is a target of behavior of a virtual object 102 moves; a virtual object behavior update unit 38 that determines behavior of the virtual object 102 in relation to the new target physical object in a case where the new target physical object is determined; and a display control unit 31 that displays the virtual object in the real space 100 with the determined behavior.

Thus, in a case where the target physical object that is the target of the behavior of the virtual object 102 moves, the information processing apparatus 2 can determine a new target physical object, immediately determine the new target physical object, and move the virtual object so as to perform the behavior in relation to the target physical object.

Therefore, the information processing apparatus 2 can reduce the display of the virtual object 102 with an uncomfortable feeling as much as possible, and can reduce the unstable behavior of the virtual object 102 when the virtual object 102 is superimposed on the physical object 101 and displayed.

Furthermore, it is conceivable that the target physical object determination unit 37 retrieves a candidate to be a target physical object from among a plurality of the physical objects and determines a new target physical object from among the retrieved candidates.

Therefore, the information processing apparatus 2 can determine an optimal new target physical object that is a target of the behavior of the virtual object 102.

Furthermore, it is conceivable that the target physical object determination unit 37 performs filtering processing of excluding a candidate that cannot be set as the new target physical object.

Therefore, the information processing apparatus 2 can prevent in advance the behavior of the virtual object 102 from being unstable when the candidate that cannot obviously be the target physical object is determined as the target physical object. Furthermore, the information processing apparatus 2 can reduce the processing load in the subsequent stage by excluding a candidate that cannot obviously be the target physical object.

Furthermore, it is conceivable that the target physical object determination unit 37 calculates a priority for the candidate and determines a new target physical object on the basis of the calculated priority.

Therefore, the information processing apparatus 2 can determine an optimal new target physical object that is the target of the behavior of the virtual object 102 by calculating the priority satisfying the set condition.

Furthermore, it is conceivable that an affordance is set for the physical object 101, and the target physical object determination unit 37 sets, as a candidate, the physical object 101 that matches the affordance set for the target physical object that has moved.

Thus, by selecting the physical object 101 that matches the affordance of the old target physical object as the candidate for the new target physical object, it is not necessary to change the behavior of the virtual object 102 when the candidate is determined as the new target physical object. Therefore, the unstable behavior of the virtual object 102 can be further reduced.

Furthermore, it is conceivable that the target physical object determination unit 37 sets, as a candidate, the physical object that satisfies a condition used for determining the target physical object that has moved.

Thus, by selecting the physical object 101 that satisfies the condition used for determining the old target physical object as the candidate for the new target physical object, the behavior of the virtual object 102 can be made similar to that of the old target physical object when the candidate is determined as the new target physical object. Therefore, the unstable behavior of the virtual object 102 can be further reduced.

Furthermore, it is conceivable that the target physical object determination unit 37 sets, as a candidate, a physical object to which the target physical object that has moved is substantially similar in size and height.

Thus, for example, it is possible to avoid a situation in which the virtual object 102 larger than the target physical object is placed on the target physical object and becomes unnatural. Therefore, the unstable behavior of the virtual object 102 can be further reduced.

Furthermore, it is conceivable that the target physical object determination unit 37 excludes a candidate having a distance to the information processing apparatus larger than a predetermined distance threshold.

Thus, it is possible to prevent the physical object 101 far away from the user from being determined as the target physical object. Therefore, it is possible to prevent the behavior of the virtual object 102 from being determined for the physical object 101 far away, and it is possible to further reduce the unstable behavior of the virtual object 102.

Furthermore, it is conceivable that the target physical object determination unit 37 excludes the candidate that cannot be visually recognized by the user.

Therefore, it is possible to prevent the behavior of the virtual object 102 from being determined for the physical object 101 present in a floor or room different from the user's place, and it is possible to further reduce the unstable behavior of the virtual object 102.

Furthermore, it is conceivable that the target physical object determination unit 37 excludes the candidate not satisfying the condition used for determining the target physical object that has moved.

Thus, since the physical object 101 not satisfying the condition used for determining the old target physical object as the candidate for the new target physical object is excluded from the candidate, the behavior of the virtual object 102 can be made similar to that of the old target physical object when the candidate is determined as the new target physical object. Therefore, the unstable behavior of the virtual object 102 can be further reduced.

Furthermore, it is conceivable that the target physical object determination unit 37 excludes the candidate for which the behavior of another virtual object 102 is set.

Thus, since the physical objects 101 for which two different virtual objects 102 are targets of the behavior are not determined as the target physical objects, it is possible to prevent the virtual objects 102 from being unnaturally superimposed and displayed. Therefore, the unstable behavior of the virtual object 102 can be further reduced.

Furthermore, it is conceivable that the target physical object determination unit 37 sets the priority higher as the distance between the position of the virtual object 102 and the position of the candidate is shorter.

Therefore, since the physical object 101 closest to the virtual object 102 is determined as the target physical object, the movement of the virtual object 102 may be small, and the unstable behavior of the virtual object 102 can be further reduced.

Furthermore, it is conceivable that the target physical object determination unit 37 sets the priority higher as the target physical object matches the condition used for determining the target physical object that has moved.

Therefore, the behavior of the virtual object 102 in relation to the physical object 101 determined as the target physical object can be stabilized, and it is possible to further reduce the unstable behavior of the virtual object 102.

Furthermore, it is conceivable that the target physical object determination unit 37 set the priority on the basis of the continuity of the user experience.

Therefore, the target physical object can be determined depending on whether or not the user is visually recognizing the target physical object, and the uncomfortable feeling given to the user can be reduced.

Furthermore, it is conceivable that the virtual object behavior update unit 38 determines the behavior of the virtual object 102 by a different method depending on whether or not the virtual object 102 is a moving object.

Thus, optimum move-display can be performed depending on whether or not the virtual object 102 is a moving object. Therefore, the unstable behavior of the virtual object 102 can be further reduced.

Furthermore, it is conceivable that in a case where the virtual object 102 is a moving object, the virtual object behavior update unit 38 calculates a movement path from the current position to a position corresponding to a new target physical object, and the display control unit 31 move-displays the virtual object according to the calculated movement path.

Therefore, in a case where the virtual object 102 is a moving object, the moving object is moved according to the movement path, and thus the uncomfortable feeling in the movement of the virtual object 102 can be reduced.

Furthermore, it is conceivable that in a case where the virtual object 102 is not a moving object, the virtual object behavior update unit 38 determines the movement pattern and display pattern from the current position to a position corresponding to the new target physical object, and the display control unit 31 displays the virtual object according to the determined movement pattern and display pattern.

Therefore, even in a case where the virtual object 102 is not a moving object, it is possible to reduce the uncomfortable feeling caused by the movement and display of the virtual object 102 by selecting the optimum movement pattern and display pattern.

Furthermore, it is conceivable that in a case where the virtual object is not a moving object, the virtual object behavior update unit 38 determines the movement pattern for moving the virtual object in accordance with another virtual object.

Therefore, since the virtual object 102 is displayed so as to be carried by another virtual object 102, it is possible to reduce the uncomfortable feeling caused by the movement and display of the virtual object 102.

Furthermore, an information processing method includes causing the information processing apparatus to: determine a movement of a physical object disposed in a real space; determine a new target physical object from among other physical objects in a case where the target physical object that is a target of behavior of a virtual object moves; determine behavior of the virtual object in relation to the new target physical object in a case where the new target physical object is determined; and display the virtual object in the real space with the determined behavior.

Furthermore, a program causes a computer to execute processing of: determining a movement of a physical object disposed in a real space; determining a new target physical object from among other physical objects in a case where the target physical object that is a target of behavior of a virtual object moves; determining behavior of the virtual object in relation to the new target physical object in a case where the new target physical object is determined; and displaying the virtual object in the real space with the determined behavior.

Such a program can be recorded in advance in an HDD as a storage medium built in a device such as a computer device, a ROM in a microcomputer having a CPU, or the like.

Alternatively, the program can be temporarily or permanently stored (recorded) in a removable storage medium such as a flexible disk, a compact disc read only memory (CD-ROM), a magneto optical (MO) disk, a digital versatile disc (DVD), a Blu-ray disc (registered trademark), a magnetic disk, a semiconductor memory, or a memory card. Such a removable storage medium can be provided as so-called package software.

Furthermore, such a program can be installed from the removable storage medium into a personal computer or the like, or can be downloaded from a download site via a network such as a local area network (LAN) or the Internet.

Furthermore, such a program is suitable for providing the information processing apparatus according to the embodiment in a wide range. For example, downloading the program to a mobile terminal device such as a smartphone or a tablet, a mobile phone, a personal computer, a video game console, a video device, a personal digital assistant (PDA), or the like allows such a device to function as the information processing apparatus of the present disclosure.

Note that effects described in the present description are merely examples and are not limited, and other effects may be provided.

### 8. Present Technology

Note that the present technology can also have the following configurations.

(1)

An information processing apparatus including:
a movement determination unit configured to determine a movement of a physical object disposed in a real space;
a target physical object determination unit configured to determine a new target physical object from among other physical objects in a case where the target physical object that is a target of behavior of a virtual object moves;
a virtual object behavior update unit configured to determine behavior of the virtual object in relation to the new target physical object in a case where the new target physical object is determined; and
a display control unit configured to display the virtual object in the real space with the determined behavior.

(2)

The information processing apparatus according to (1), in which
the target physical object determination unit
retrieves a candidate to be the target physical object from among a plurality of the physical objects and determines the new target physical object from among the retrieved candidates.

(3)

The information processing apparatus according to (2), in which
the target physical object determination unit
performs filtering processing of excluding the candidate that is not capable of being set as the new target physical object.

(4)

The information processing apparatus according to (2) or (3), in which
the target physical object determination unit
calculates a priority for the candidate and determines the new target physical object on the basis of the calculated priority.

(5)

The information processing apparatus according to any one of (2) to (4), in which
an affordance is set for the physical object, and
the target physical object determination unit
sets, as the candidate, the physical object that matches affordance information set for the target physical object that has moved.

(6)

The information processing apparatus according to any one of (2) to (5), in which
the target physical object determination unit
sets, as the candidate, the physical object satisfying a condition used for determining the target physical object that has moved.

(7)

The information processing apparatus according to any one of (2) to (6), in which
the target physical object determination unit
sets, as the candidate, the physical object to which the target physical object that has moved is substantially similar in size and height.

(8)

The information processing apparatus according to any one of (3) to (7), in which
the target physical object determination unit
excludes the candidate of which a distance to the information processing apparatus is larger than a predetermined distance threshold.

(9)

The information processing apparatus according to any one of (3) to (8), in which
the target physical object determination unit
excludes the candidate that is not capable of being visually recognized by a user.

(10)

The information processing apparatus according to any one of (3) to (9), in which
the target physical object determination unit
excludes the candidate not satisfying a condition used for determining the target physical object that has moved.

(11)

The information processing apparatus according to any one of (3) to (10), in which
the target physical object determination unit
excludes the candidate for which behavior of another virtual object is set.

(12)

The information processing apparatus according to any one of (4) to (11), in which
the target physical object determination unit
sets the priority higher as a distance between a position of the virtual object and a position of the candidate is shorter.

(13)

The information processing apparatus according to any one of (4) to (12), in which
the target physical object determination unit
sets the priority higher as a target physical object matches a condition used for determining the target physical object that has moved.

(14)

The information processing apparatus according to any one of (4) to (13), in which
the target physical object determination unit
sets the priority on the basis of continuity of user experience.

(15)

The information processing apparatus according to any one of (1) to (14), in which
the virtual object behavior update unit
determines the behavior of the virtual object by a different method depending on whether or not the virtual object is a moving object.

(16)

The information processing apparatus according to (15), in which
in a case where the virtual object is the moving object, the virtual object behavior update unit calculates a movement path from a current position to a position corresponding to the new target physical object, and
the display control unit
move-displays the virtual object according to the calculated movement path.

(17)

The information processing apparatus according to (15) or (16), in which
in a case where the virtual object is not the moving object, the virtual object behavior update unit determines a movement pattern and display pattern from a current position to a position corresponding to the new target physical object, and
the display control unit
displays the virtual object according to the determined movement pattern and display pattern.

(18)

The information processing apparatus according to (17), in which
in a case where the virtual object is not the moving object, the virtual object behavior update unit determines the movement pattern for moving the virtual object in accordance with another virtual object.

(19)

An information processing method including causing an information processing apparatus to:
determine a movement of a physical object disposed in a real space;
determine a new target physical object from among other physical objects in a case where the target physical object that is a target of behavior of a virtual object moves;
determine behavior of the virtual object in relation to the new target physical object in a case where the new target physical object is determined; and
display the virtual object in the real space with the determined behavior.

(20)

A program causing a computer to execute processing of:
determining a movement of a physical object disposed in a real space;
determining a new target physical object from among other physical objects in a case where the target physical object that is a target of behavior of a virtual object moves;
determining behavior of the virtual object in relation to the new target physical object in a case where the new target physical object is determined; and
displaying the virtual object in the real space with the determined behavior.

### REFERENCE SIGNS LIST

1 Information processing system
2 Information processing apparatus
3 Server
11 CPU
17 Display unit
31 Display control unit
36 Movement determination unit
37 Target physical object determination unit
38 Virtual object behavior update unit

1. An information processing apparatus comprising:
a movement determination unit configured to determine a movement of a physical object disposed in a real space;
a target physical object determination unit configured to determine a new target physical object from among other physical objects in a case where the target physical object that is a target of behavior of a virtual object moves;
a virtual object behavior update unit configured to determine behavior of the virtual object in relation to the new target physical object in a case where the new target physical object is determined; and
a display control unit configured to display the virtual object in the real space with the determined behavior.

2. The information processing apparatus according to claim 1, wherein
the target physical object determination unit
retrieves a candidate to be the target physical object from among a plurality of the physical objects and determines the new target physical object from among the retrieved candidates.

3. The information processing apparatus according to claim 2, wherein
the target physical object determination unit
performs filtering processing of excluding the candidate that is not capable of being set as the new target physical object.

4. The information processing apparatus according to claim 2, wherein
the target physical object determination unit
calculates a priority for the candidate and determines the new target physical object on a basis of the calculated priority.

5. The information processing apparatus according to claim 2, wherein
an affordance is set for the physical object, and
the target physical object determination unit
sets, as the candidate, the physical object that matches affordance information set for the target physical object that has moved.

6. The information processing apparatus according to claim 2, wherein
the target physical object determination unit
sets, as the candidate, the physical object satisfying a condition used for determining the target physical object that has moved.

7. The information processing apparatus according to claim 2, wherein
the target physical object determination unit
sets, as the candidate, the physical object to which the target physical object that has moved is substantially similar in size or height.

8. The information processing apparatus according to claim 3, wherein
the target physical object determination unit
excludes the candidate of which a distance to the information processing apparatus is larger than a predetermined distance threshold.

9. The information processing apparatus according to claim 3, wherein
the target physical object determination unit
excludes the candidate that is not capable of being visually recognized by a user.

10. The information processing apparatus according to claim 3, wherein
the target physical object determination unit
excludes the candidate not satisfying a condition used for determining the target physical object that has moved.

11. The information processing apparatus according to claim 3, wherein
the target physical object determination unit
excludes the candidate for which behavior of another virtual object is set.

12. The information processing apparatus according to claim 4, wherein
the target physical object determination unit
sets the priority higher as a distance between a position of the virtual object and a position of the candidate is shorter.

13. The information processing apparatus according to claim 4, wherein
the target physical object determination unit
sets the priority higher as a target physical object matches a condition used for determining the target physical object that has moved.

14. The information processing apparatus according to claim 4, wherein
the target physical object determination unit
sets the priority on a basis of continuity of user experience.

15. The information processing apparatus according to claim 1, wherein
the virtual object behavior update unit
determines the behavior of the virtual object by a different method depending on whether or not the virtual object is a moving object.

16. The information processing apparatus according to claim 15, wherein
in a case where the virtual object is the moving object, the virtual object behavior update unit calculates a movement path from a current position to a position corresponding to the new target physical object, and
the display control unit
move-displays the virtual object according to the calculated movement path.

17. The information processing apparatus according to claim 15, wherein
in a case where the virtual object is not the moving object, the virtual object behavior update unit determines a movement pattern and display pattern from a current position to a position corresponding to the new target physical object, and
the display control unit
displays the virtual object according to the determined movement pattern and display pattern.

18. The information processing apparatus according to claim 17, wherein
in a case where the virtual object is not the moving object, the virtual object behavior update unit determines the movement pattern for moving the virtual object in accordance with another virtual object.

19. An information processing method comprising causing an information processing apparatus to:
determine a movement of a physical object disposed in a real space;
determine a new target physical object from among other physical objects in a case where the target physical object that is a target of behavior of a virtual object moves;
determine behavior of the virtual object in relation to the new target physical object in a case where the new target physical object is determined; and
display the virtual object in the real space with the determined behavior.

20. A program causing a computer to execute processing of:
determining a movement of a physical object disposed in a real space;
determining a new target physical object from among other physical objects in a case where the target physical object that is a target of behavior of a virtual object moves;
determining behavior of the virtual object in relation to the new target physical object in a case where the new target physical object is determined; and
displaying the virtual object in the real space with the determined behavior.
